(19) United States
(12) Patent Application Publication
(10) Pub. No.: US 2026/0229977 A1
(43) Pub. Date: Aug. 6, 2026

(54) LINEAR MOTOR ARMATURE AND MANUFACTURING METHOD FOR SAME

(71) Applicant: FANUC CORPORATION, Yamanashi (JP)

(72) Inventors: Akira NISHIFUKUMOTO, Yamanashi-ken (JP); Yuusuke KONDOU, Yamanashi-ken (JP)

(21) Appl. No.: 19/147,166

(22) PCT Filed: Jan. 17, 2023
(86) PCT No.: PCT/JP2023/001159

§ 371 Date: Jul. 10, 2025

(51) Int. Cl. H02K 41/03; H02K 1/26; H02K 15/026; H02K 15/121

(52) U.S. Cl. CPC H02K 41/031; H02K 1/26; H02K 15/026; H02K 15/121

(57) ABSTRACT

The present disclosure pertains to a linear motor armature comprising: a core having a plurality of teeth and a plurality of slots; a resin mold; and a sheet-like reinforcement member. The reinforcement member has formed therein a recess part recessed toward the side opposite to the teeth. The recess part is continuous in the lateral surface orthogonal to the thickness direction of the reinforcement member. The recess part is filled with a resin material.

### TECHNICAL FIELD

The present disclosure relates to a linear motor armature and a method of manufacturing the same.

### BACKGROUND ART

JP H05-111234 A discloses a linear motor armature in which a fiber reinforced resin sheet is provided on a wall portion on a resin mold that faces teeth. The resin mold covers a core.

### SUMMARY OF THE INVENTION

It is desirable to provide a better linear motor armature and method of manufacturing the same.

A first aspect of the present disclosure is a linear motor armature equipped with a core including a plurality of teeth and a plurality of slots, a coil being provided in each of the plurality of slots, a resin mold made of a resin material and covering the core, and a reinforcing member having a sheet shape and being provided on a wall portion of the resin mold, the wall portion facing the plurality of teeth, in order to reinforce the wall portion, wherein the reinforcing member includes a recessed portion that is recessed away from the plurality of the teeth, the recessed portion is connected to a side surface of the reinforcing member that faces perpendicularly to a thickness direction of the reinforcing member, and the recessed portion is filled with the resin material.

A second aspect of the present disclosure is a method of manufacturing a linear motor armature, the linear motor armature including a core including a plurality of teeth and a plurality of slots, a coil being provided in each of the plurality of slots, a resin mold made of a resin material and covering the core, and a reinforcing member having a sheet shape and being provided on a wall portion of the resin mold, the wall portion facing the plurality of teeth, in order to reinforce the wall portion, the method including a preparation step of preparing a sheet member including a recessed portion formed in a surface of the sheet member, an arrangement step of arranging the sheet member on a bottom surface of a mold in a manner that the recessed portion faces upward, a placement step of placing the core on the sheet member in a manner so that the plurality of teeth are brought into contact with the sheet member, and a molding step of molding the resin mold by injecting a liquid resin into the mold and solidifying the liquid resin, wherein in the molding step, the sheet member becomes the reinforcing member, and the recessed portion is filled with the liquid resin.

### BRIEF DESCRIPTION OF DRAWINGS

FIG. 1 is a longitudinal cross-sectional view of a linear motor armature; FIG. 1 is a cross-sectional view taken along line I-I of FIG. 2;

FIG. 2 is a transverse cross-sectional view taken along line II-II of FIG. 1;

FIG. 3 is a flowchart illustrating a method of manufacturing the linear motor armature;

FIG. 4 FIGS. 4A and 4B are explanatory diagrams of a preparation step;

FIG. 5 is an explanatory diagram of an arrangement step and a placement step;

FIG. 6 is a first explanatory diagram of the molding step;

FIG. 7 is a second explanatory diagram of the molding step;

FIG. 8A is a transverse cross-sectional view of a linear motor armature including a reinforcing member according to Modification 1; and FIG. 8B is a transverse cross-sectional view of a linear motor armature including a reinforcing member according to Modification 2.

### DETAILED DESCRIPTION OF THE INVENTION

The linear motor armature according to the above-described conventional technique is formed by injecting a liquid resin into a mold and solidifying it in a state that teeth of a core are brought into contact with a fibrous sheet member disposed on the bottom surface of the mold. In this case, the fibrous sheet member is impregnated with the liquid resin to form the fiber reinforced resin sheet. However, the liquid resin is less likely to permeate into the sheet member. Therefore, for example, when the entire surface of the teeth facing the sheet member is in contact with the sheet member, there is a possibility that the entire core cannot be covered with the resin mold.

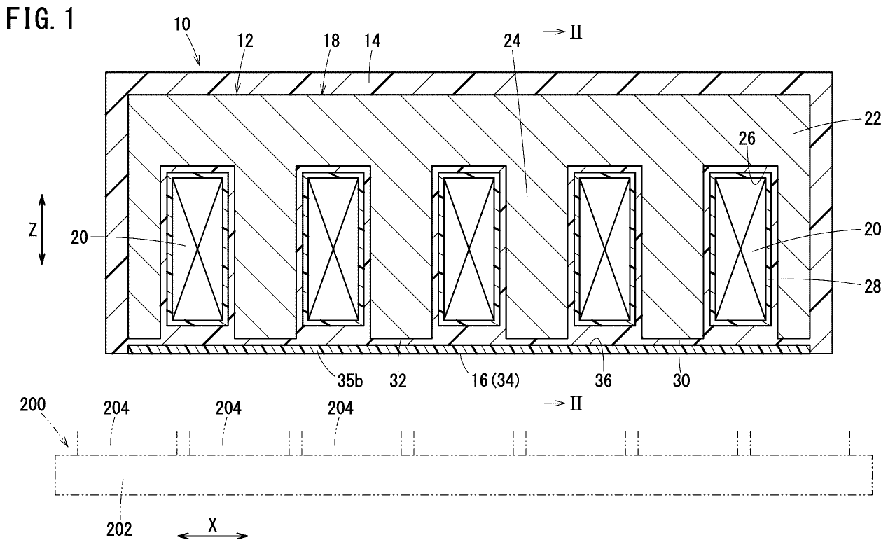

A linear motor armature 10 according to the present embodiment and a method of manufacturing the same will be described below with reference to the drawings. As shown in FIG. 1, the linear motor armature 10 is disposed to face a stator 200, and forms a movable element that moves under a thrust.

The stator 200 includes a base plate 202 extending in one direction (the direction of arrow X) and a plurality of magnets 204 provided on the base plate 202. The plurality of magnets 204 are arranged at equal intervals in the direction of arrow X. The magnets 204 are permanent magnets.

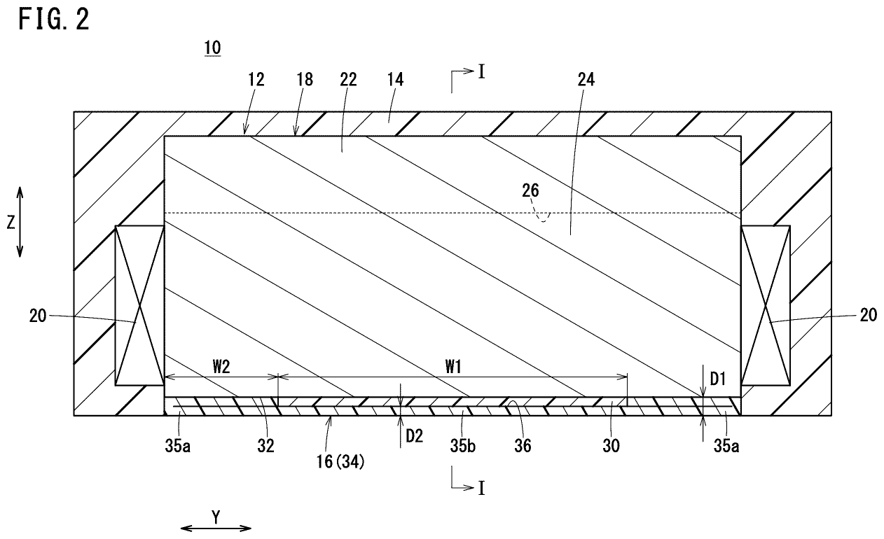

As shown in FIGS. 1 and 2, the linear motor armature 10 has a rectangular parallelepiped shape. The linear motor armature 10 extends in the direction of arrow X. The linear motor armature 10 is provided with a core 12, a resin mold 14, and a reinforcing member 16.

As shown in FIG. 1, the core 12 includes a core body 18 and a plurality of coils 20. The core body 18 is formed by stacking, for example, a plurality of electromagnetic steel plates. The core body 18 has a yoke 22, a plurality of teeth 24, and a plurality of slots 26.

The yoke 22 extends in the direction of arrow X. The teeth 24 project from the yoke 22 in the thickness direction (the direction of arrow Z) of the yoke 22. The plurality of teeth 24 are arranged at intervals in the direction of arrow X. The dimension of the teeth 24 in the widthwise direction (the dimension in the direction of arrow Y) is the same as the dimension of the yoke 22 in the widthwise direction (the dimension in the direction of arrow Y) (see FIG. 2). The slots 26 are gaps formed between adjacent teeth 24. The positions, sizes, shapes, and the like of the yoke 22, the teeth 24, and the slots 26 can be set as appropriate.

The coil 20 is provided in each of the plurality of slots 26. The coils 20 include conductive wires (not shown) wound around the teeth 24. The slot 26 is provided with insulating paper 28 for preventing electrical connection between the coil 20 and the core body 18.

As shown in FIGS. 1 and 2, the resin mold 14 is made of a resin material and covers the entire core 12. The resin material constituting the resin mold 14 has an electrical insulating property. As a resin material constituting the resin mold 14, for example, a thermosetting resin such as an epoxy resin, a phenol resin, a polyamide resin, or the like is used. The resin material constituting the resin mold 14 may be a thermoplastic resin such as methyl methacrylate. The resin mold 14 is also provided inside the slots 26 (see FIG. 1).

The reinforcing member 16 is formed in a sheet shape. The reinforcing member 16 has an electrical insulating property. The reinforcing member 16 is provided on a wall portion 30 of the resin mold 14 on a teeth 24 side. The wall portion 30 of the resin mold 14 is a portion adjacent to projecting end surfaces 32 of the teeth 24.

The reinforcing member 16 includes a fiber reinforced resin (FRP: fiber reinforced plastics). The fiber reinforced resin includes, for example, glass fibers. The fiber reinforced resin may include fibers other than glass fibers. The fiber reinforced resin may contain a plurality of types of fibers. The fibers of the fiber reinforced resin preferably have electrical insulating properties.

As shown in FIG. 2, the reinforcing member 16 is formed by folding opposite ends of a fiber reinforced resin sheet 34.

Specifically, the fiber reinforced resin sheet 34 is folded such that opposite ends thereof in a direction (the direction of arrow Y) perpendicular to the arrangement direction of the plurality of teeth 24 are folded toward the teeth 24. That is, the fiber reinforced resin sheet 34 has a double sheet at each end portion in the direction of arrow Y.

A thickness D1 of end portions 35a of the reinforcing member 16 in the direction of arrow Y is larger than a thickness D2 of a central portion 35b of the reinforcing member 16 in the direction of arrow Y. The end portions 35a are folded portions, and the central portion 35b is an unfolded portion. A thickness of the wall portion 30 of the resin mold 14 is determined by the thickness D1 of the end portions 35a of the reinforcing member 16. That is, the thickness D1 of the end portions 35a of the reinforcing member 16 is the same as a thickness of the wall portion 30 of the resin mold 14. The thickness D1 of the end portions 35a of the reinforcing member 16 (the thickness of the wall portion 30 of the resin mold 14) is preferably 0.1 mm or more and 0.3 mm or less, and more preferably about 0.2 mm. In this case, a magnetic gap between the core 12 and the stator 200 (see FIG. 1) can be narrowed.

A recessed portion 36 that is recessed away from the teeth 24 is formed in the reinforcing member 16. The recessed portion 36 is located between the opposite end portions 35a of the reinforcing member 16. As shown in FIG. 1, the recessed portion 36 extends over the overall length of the reinforcing member 16 in the direction of arrow X. In other words, the recessed portion 36 is connected to the side surfaces (outer surfaces) of the reinforcing member 16 facing in the direction of arrow X. As shown in FIG. 2, a dimension W1 of the recessed portion 36 in the widthwise direction (the direction of arrow Y) is larger than a dimension W2 of each of the opposite end portions 35a of the reinforcing member 16 in the direction of arrow Y. The recessed portion 36 is filled with a resin material. The resin material filled in the recessed portion 36 forms the wall portion 30.

The opposite end portions 35a of the reinforcing member 16 are in contact with the projecting end surfaces 32 of the teeth 24. The central portion 35b of the reinforcing member 16 is spaced from the projecting end surfaces 32 of the teeth 24. The dimension of the reinforcing member 16 in the direction of arrow X is the same as the dimension of the core 12 in the direction of arrow X (see FIG. 1). The dimension of the reinforcing member 16 in the direction of arrow Y is the same as the dimension of the core body 18 in the direction of arrow Y. The size, shape, and the like of the reinforcing member 16 can be changed as appropriate.

Next, a method of manufacturing the linear motor armature 10 will be described.

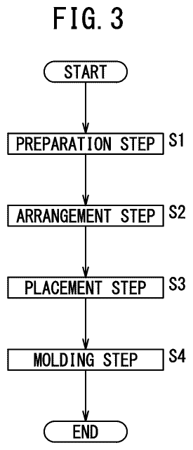

As shown in FIG. 3, the method of manufacturing the linear motor armature 10 of the present embodiment includes a preparation step, an arrangement step, a placement step, and a molding step.

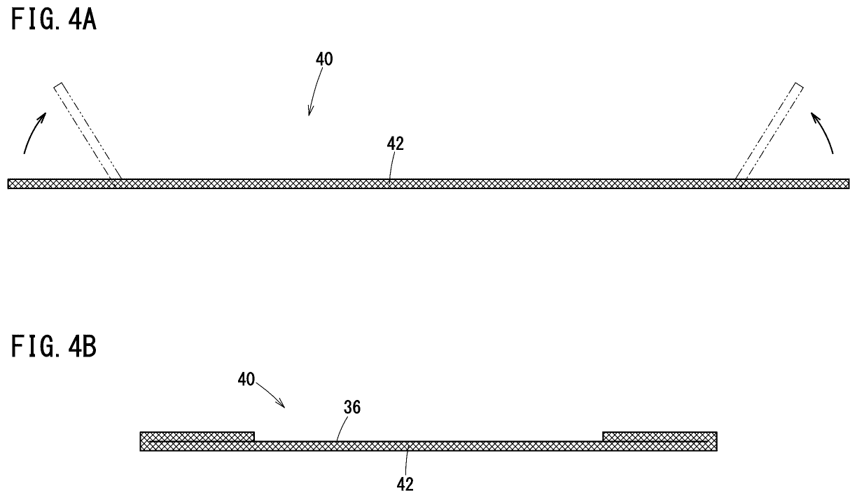

In the preparation step (step S1), as shown in FIGS. 4A and 4B, a sheet member 40 having a predetermined shape is prepared. Specifically, the sheet member 40 is formed by folding opposite ends of a rectangular fiber sheet 42. The size and shape of the sheet member 40 are the same as those of the fiber reinforced resin sheet 34 described above. The sheet member 40 is formed with a recessed portion 36. After the preparation step is completed, the process proceeds to the arrangement step.

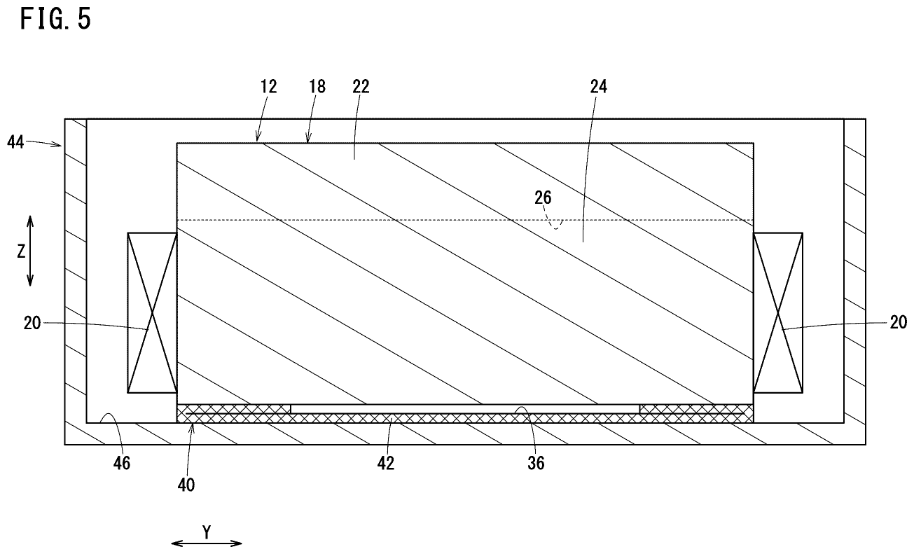

In the arrangement step (step S2 in FIG. 3), as shown in FIG. 5, the sheet member 40 is arranged at the central portion of a bottom surface 46 of a mold 44. The recessed portion 36 of the sheet member 40 is open upward. After the arrangement step is completed, the process proceeds to the placement step.

In the placement step (step S3 in FIG. 3), the core 12 is placed on the sheet member 40. The projecting end surfaces 32 of the teeth 24 are brought into contact with the end portions of the sheet member 40. After the placement step is completed, the process proceeds to the molding step.

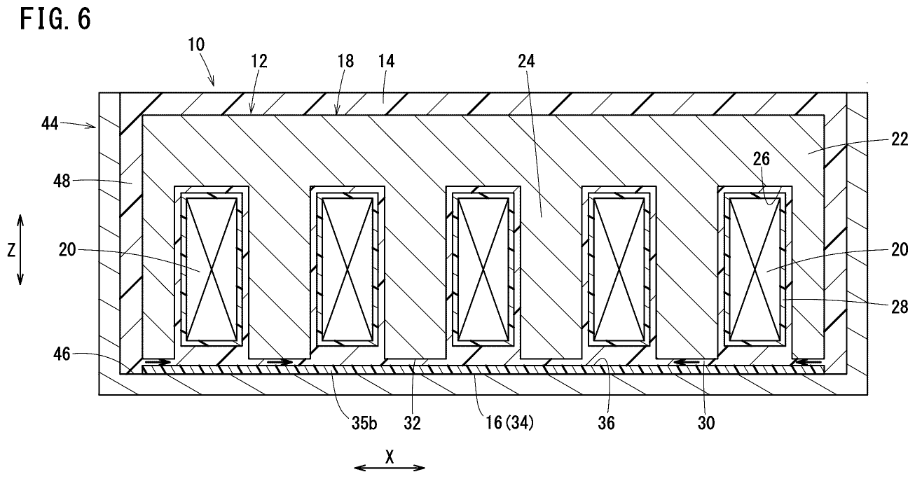

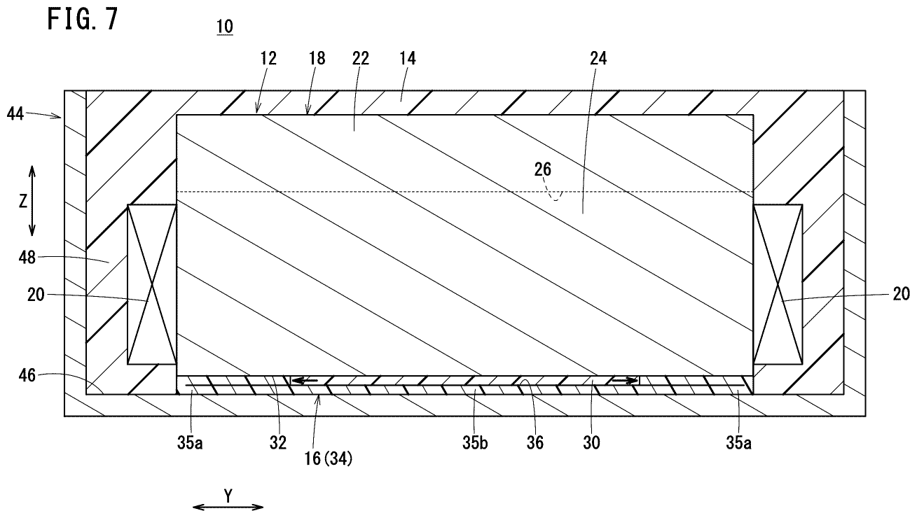

In the molding step (step S4 in FIG. 3), as shown in FIGS. 6 and 7, a liquid resin (resin material) 48 is injected into the mold 44. The liquid resin 48 injected into the mold 44 accumulates so as to surround the sheet member 40. Also as shown in FIG. 6, the liquid resin 48 flows from both ends of the sheet member 40 in the direction of arrow X into the recessed portion 36, and flows in the recessed portion 36 toward the center of the sheet member 40 in the direction of arrow X. At this time, the liquid resin 48 also flows through each of the plurality of slots 26. The liquid resin 48 around the sheet member 40 permeates into the sheet member 40 (the fiber sheet 42) (see FIG. 7).

As shown in FIGS. 6 and 7, when the liquid resin 48 covers the upper surface of the core 12, the injection of the liquid resin 48 into the mold 44 is stopped. Thereafter, the liquid resin 48 is solidified to form the resin mold 14. The liquid resin 48 permeating into the sheet member 40 (the liquid resin with which the sheet member 40 is impregnated) is solidified to form the fiber reinforced resin sheet 34 (reinforcing member 16). That is, the linear motor armature 10 is manufactured when the molding step is completed.

According to the present embodiment, the following advantageous effects are obtained.

In the present embodiment, in the linear motor armature 10, the sheet-shaped reinforcing member 16 is provided on the wall portion 30 on the teeth 24 side of the resin mold 14, so that the wall portion 30 can be reinforced. The reinforcing member 16 is formed with the recessed portion 36 that is recessed away from the teeth 24. The recessed portion 36 is connected to side surfaces of the reinforcing member 16 that face perpendicularly to the thickness direction. The recessed portion 36 is filled with a resin material. Therefore, the resin material (liquid resin 48) can be supplied more easily between the teeth 24 and the reinforcing member 16 than in the case where the concave portion 36 is not formed in the reinforcing member 16, and therefore the entire core 12 can be covered with the resin mold 14. As a result, a more satisfactory linear motor armature 10 can be obtained.

The reinforcing member 16 includes a fiber reinforced resin. In accordance with such a configuration, the wall portion 30 of the resin mold 14 can be reinforced easily and efficiently.

The reinforcing member 16 is formed by folding opposite ends of the fiber reinforced resin sheet 34. In accordance with such a configuration, the recessed portion 36 can be easily formed in the reinforcing member 16. The thickness of the wall portion 30 of the resin mold 14 can be defined by the thickness D1 (dimension in the direction of arrow Z) of the opposite end portions 35a of the fiber reinforced resin sheet 34.

The plurality of teeth 24 are arranged in one direction (the direction of arrow X). The fiber reinforced resin sheet 34 is folded at opposite ends thereof in a direction (arrow Y direction) perpendicular to the arrangement direction of the teeth 24. In accordance with such a configuration, the variation in thickness of the wall portion 30 of the resin mold 14 in the direction of arrangement of the plurality of teeth 24 (the direction of the arrow X) can be suppressed.

In the method of manufacturing the linear motor armature 10, in the preparation step, the sheet member 40 having the recessed portion 36 formed in the surface thereof is prepared. In the arrangement step, the sheet member 40 is arranged on the bottom surface 46 of the mold 44 so that the recessed portion 36 faces upward. In the placement step, the core 12 is placed on the sheet member 40 such that the teeth 24 are brought into contact with the sheet member 40. In the molding step, the liquid resin 48 injected into the mold 44 is solidified to form the resin mold 14. In the molding step, the sheet member 40 serves as the reinforcing member 16 and the liquid resin 48 is filled in the concave portion 36. According to such a method, the above-mentioned linear motor armature 10 can be easily manufactured.

The sheet member 40 is the fiber sheet 42. In the molding step, the fiber sheet 42 is impregnated with the resin material to form the fiber reinforced resin. According to such a method, the fiber reinforced resin sheet 34 (reinforcing member 16) can be easily formed.

In the preparation step, the sheet member 40 is formed by folding opposite ends of the fiber sheet 42. According to such a method, the sheet member 40 can be easily prepared.

The above-described embodiment may be modified in the following manner. In the following modifications, descriptions that overlap or are duplicative of those stated in the embodiment will be omitted. In the drawings used in the following modification, the same reference numerals are used for the same components as those described in the embodiment.

### Modification 1

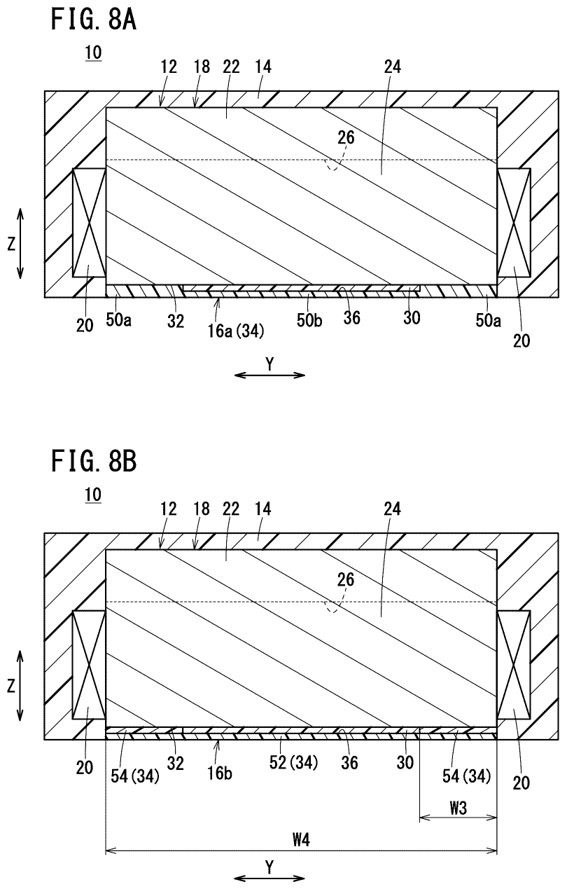

As shown in FIG. 8A, a reinforcing member 16a of the linear motor armature 10 according to Modification 1 is formed in a sheet shape. The reinforcing member 16a is integrally formed such that opposite end portions 50a of the reinforcing member 16a in the direction of arrow Y project further toward the teeth 24 than a central portion 50b of the reinforcing member 16a in the direction of arrow Y.

The reinforcing member 16a is formed with a recessed portion 36. The recessed portion 36 is formed by, for example, machining. Opposite ends of the reinforcing member 16a in the direction of arrow Y are not folded. The reinforcing member 16a is the fiber reinforced resin sheet 34. In accordance with such a configuration, it is not necessary to fold opposite ends of the reinforcing member 16a.

### Modification 2

As shown in FIG. 8B, a reinforcing member 16b of the linear motor armature 10 according to Modification 2 includes a sheet body 52 and a pair of spacers 54. The thickness of the sheet body 52 at opposite end portions thereof in the direction of arrow Y is the same as the thickness of the sheet body 52 at the central portion thereof in the direction of arrow Y.

The spacers 54 are placed on opposite end portions of the sheet body 52 in the direction of arrow Y. Each of the spacers 54 is formed in a sheet shape. The spacers 54 are in contact with the projecting end surfaces 32 of the teeth 24. A dimension W3 of each of the spacers 54 in the widthwise direction (the direction of arrow Y) is less than half of a dimension W4 of the sheet body 52 in the widthwise direction. A recessed portion 36 is formed between the pair of spacers 54. The sheet body 52 and the spacers 54 are formed of a fiber reinforced resin sheet 34. In accordance with such a configuration, it is not necessary to fold opposite ends of the reinforcing member 16b.

In each of the above-described embodiment, Modification 1, and Modification 2, the size, shape, position, and the like of the recessed portion 36 can be set appropriately, as long as the recessed portion 36 is connected to the side surface that faces perpendicular to the thickness direction of each of the reinforcing members 16, 16a, and 16b. The reinforcing members 16, 16a, and 16b need not necessarily be the fiber reinforced resin sheets 34. The reinforcing members 16, 16a, and 16b may be porous sheets impregnated with a resin material. The reinforcing members 16, 16a, and 16b may be sheets or plates (metal plates or resin plates) through which the resin material does not permeate.

With respect to the above embodiment, the following supplementary notes are further disclosed.

### Supplementary Note 1

The present disclosure is the linear motor armature (10) includes the core (12) including the plurality of teeth (24) and the plurality of slots (26), the coil (20) being provided in each of the plurality of slots, the resin mold (14) made of the resin material and covering the core, and the reinforcing member (16, 16a, 16b) having the sheet shape and being provided on the wall portion (30) of the resin mold, the wall portion facing the plurality of teeth, in order to reinforce the wall portion, wherein the reinforcing member includes the recessed portion (36) that is recessed away from the plurality of the teeth, the recessed portion is connected to the side surface of the reinforcing member that faces perpendicularly to the thickness direction of the reinforcing member, and the recessed portion is filled with the resin material.

### Supplementary Note 2

In the linear motor armature according to Supplementary Note 1, the reinforcing member may include the fiber reinforced resin.

### Supplementary Note 3

In the linear motor armature according to Supplementary Note 2, the reinforcing member may be formed by folding opposite ends of the fiber reinforced resin sheet (34).

### Supplementary Note 4

In the linear motor armature according to Supplementary Note 3, the plurality of teeth may be arranged in the direction, and the opposite ends of the fiber reinforced resin sheet in the direction perpendicular to the direction in which the plurality of teeth are arranged, may be folded.

### Supplementary Note 5

In the linear motor armature according to Supplementary Note 1 or 2, the reinforcing member may be integrally formed in the manner so that opposite end portions (50a) of the reinforcing member project further toward the plurality of teeth than the central portion (50b) of the reinforcing member.

### Supplementary Note 6

The present disclosure is the method of manufacturing the linear motor armature, and the linear motor armature includes the core including the plurality of teeth and the plurality of slots, the coil being provided in each of the plurality of slots, the resin mold made of the resin material and covering the core, and the reinforcing member having the sheet shape and being provided on the wall portion of the resin mold, the wall portion facing the plurality of teeth, in order to reinforce the wall portion. The method includes the preparation step (step S1) of preparing the sheet member (40) including the recessed portion formed in the surface of the sheet member, the arrangement step (step S2) of arranging the sheet member on the bottom surface (46) of the mold (44) in the manner so that the recessed portion faces upward, the placement step (step S3) of placing the core on the sheet member in the manner so that the plurality of teeth are brought into contact with the sheet member, and the molding step (step S4) of molding the resin mold by injecting the liquid resin (48) into the mold and solidifying the liquid resin, wherein in the molding step, the sheet member becomes the reinforcing member, and the recessed portion is filled with the liquid resin.

### Supplementary Note 7

In the method of manufacturing the linear motor armature according to Supplementary Note 6, the sheet member may be the fiber sheet (42), and in the molding step, the fiber sheet may be impregnated with the resin material so as to be formed into the fiber reinforced resin sheet.

### Supplementary Note 8

In the method of manufacturing the linear motor armature according to Supplementary Note 7, in the preparation step, the sheet member may be formed by folding opposite ends of the fiber sheet.

Although the present disclosure has been described in detail, the present disclosure is not limited to each of the embodiments described above. Within a range that does not depart from the essence and gist of the present disclosure, or within a range that does not depart from the purpose of the present disclosure derived from the content described in the claims and their equivalents, various additions, substitutions, changes, partial deletions, or the like can be made to such embodiments. These embodiments may also be implemented in combination. For example, in the embodiments described above, the order of the operations and the order of the processes are shown as examples, and the present invention is not limited to such operations and processes. The same applies to the case where numerical values or mathematical expressions are used in the description of the above-described embodiments.

### REFERENCE SIGNS LIST

10: linear motor armature
12: core
14: resin mold
16, 16a, 16b: reinforcing member
20: coil
24: teeth
26: slot
30: wall portion
34: fiber reinforced resin sheet
36: recessed portion
40: sheet member
42: fiber sheet
44: mold
46: bottom surface
48: liquid resin

1. A linear motor armature comprising:
a core including a plurality of teeth and a plurality of slots, a coil being provided in each of the plurality of slots;
a resin mold made of a resin material and covering the core; and
a reinforcing member having a sheet shape and being provided on a wall portion of the resin mold, the wall portion facing the plurality of teeth, in order to reinforce the wall portion,
wherein the reinforcing member includes a recessed portion that is recessed away from the plurality of the teeth,
the recessed portion is connected to a side surface of the reinforcing member that faces perpendicularly to a thickness direction of the reinforcing member, and
the recessed portion is filled with the resin material.

2. The linear motor armature according to claim 1, wherein the reinforcing member includes a fiber reinforced resin.

3. The linear motor armature according to claim 2, wherein the reinforcing member is formed by folding opposite ends of a fiber reinforced resin sheet.

4. The linear motor armature according to claim 3, wherein the plurality of teeth are arranged in a direction, and
the opposite ends of the fiber reinforced resin sheet in a direction perpendicular to the direction in which the plurality of teeth are arranged, are folded.

5. The linear motor armature according to claim 1, wherein the reinforcing member is integrally formed in a manner so that opposite end portions of the reinforcing member project further toward the plurality of teeth than a central portion of the reinforcing member.

6. A method of manufacturing a linear motor armature, the linear motor armature including:
a core including a plurality of teeth and a plurality of slots, a coil being provided in each of the plurality of slots;
a resin mold made of a resin material and covering the core; and
a reinforcing member having a sheet shape and being provided on a wall portion of the resin mold, the wall portion facing the plurality of teeth, in order to reinforce the wall portion,
the method comprising:
a preparation step of preparing a sheet member including a recessed portion formed in a surface of the sheet member;
an arrangement step of arranging the sheet member on a bottom surface of a mold in a manner so that the recessed portion faces upward;
a placement step of placing the core on the sheet member in a manner so that the plurality of teeth are brought into contact with the sheet member; and
a molding step of molding the resin mold by injecting a liquid resin into the mold and solidifying the liquid resin,
wherein in the molding step, the sheet member becomes the reinforcing member, and the recessed portion is filled with the liquid resin.

7. The method of manufacturing the linear motor armature according to claim 6, wherein the sheet member is a fiber sheet, and
in the molding step, the fiber sheet is impregnated with the resin material so as to be formed into a fiber reinforced resin sheet.

8. The method of manufacturing the linear motor armature according to claim 7, wherein in the preparation step, the sheet member is formed by folding opposite ends of the fiber sheet.
